(19) United States
(12) Patent Application Publication
(10) Pub. No.: US 2009/0180287 A1
(43) Pub. Date: Jul. 16, 2009

(54) LAMPSHADE FOR A LIGHT-EMITTING DIODE (LED) LAMP

(76) Inventor: Shih Chuan Tang, Tucheng City (TW)

Correspondence Address: EGBERT LAW OFFICES, 412 MAIN STREET, 7TH FLOOR, HOUSTON, TX, 77002, US

(21) Appl. No.: 12/013,462

(22) Filed: Jan. 13, 2008

(51) Int. Cl. F21V 1/02

(52) U.S. Cl. 362/351

(57) ABSTRACT

The present invention provides an improved lampshade for a light-emitting diode (LED) lamp, which is assembled onto the port of a hold tank on the main body of the LED lamp. The light-reflection modules, located between a port of a hold tank and LED modules in the hold tank, are positioned securely. The lampshade include a circumferential locating edge and a limitation surface. The circumferential locating edge is adapted to the wall edge of hold tank to define an inner edge and an external edge. The limitation surface is recessed into an inner edge of the circumferential locating edge and is provided with through-holes for sleeving and limitation of the light-reflection modules. A snapping portion is placed at the coupling portion of the circumferential locating edge and wall edge of the hold tank for positioning the lampshade.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a light-emitting diode (LED) lamp, and more particularly to an innovative lamp with an improved lampshade.

2. Description of Related Art Including Information Disclosed Under 37 CFR 1.97 and 37 CFR 1.98.

An LED lamp generally comprises a main body, LED module, heat-radiating component and lampshade.

The lampshade of the LED lamp is generally developed from a traditional light shield. However, LEDs in the LED lamp are distributed in a spotted state, so every LED is fitted with a light-reflection module to magnify the light spots, softening the bright light and generating a decorative spotted effect. Considering the assembly and disassembly work, every light-reflection module must be positioned securely.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

Through the structures of the lampshade, the circumferential locating edge, limitation surface, through-hole and snapping portion are combined. The circumferential locating edge is adapted to the wall edge of the hold tank, providing the lampshade with a reliable, circular support surface. The limitation surface of the lampshade is recessed into an inner edge of the circumferential locating edge, permitting the light-emitting surface of the light-reflection module to recess slightly and making light-emitting surface aesthetically pleasing. The through-hole on the limitation surface of the lampshade enables rapid sleeving and limitation of the light-reflection modules. With the circumferential locating edge and snapping portion on the wall edge of the hold tank, the lampshade and main body can be positioned and removed rapidly and easily. Thus, the lampshade is formed such that the light-reflection module could be positioned securely and removed easily.

Based upon the structures of the present invention, the circumferential locating edge of the lampshade has a stepped external wall with big and small necks, and the wall edge of the hold tank has a stepped inner wall with big and small treads. The coupling area of the circumferential locating edge of the lampshade and the wall edge of hold tank could be further expanded for better assembly and positioning effects.

Based upon the structures of the present invention, a shoulder is formed at one end of the light-reflection module. The shoulder is located in the through-hole of the limitation surface of the lampshade to further securely fix the light-reflection modules.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled perspective view of the preferred embodiment of the present invention.

FIG. 2 shows an exploded perspective view of the preferred embodiment of the present invention.

FIG. 3 shows an exploded sectional view of the preferred embodiment of the present invention.

FIG. 4 shows an assembled sectional view of the preferred embodiment of the present invention.

FIG. 5 shows a partially enlarged sectional view of portion B of FIG. 4.

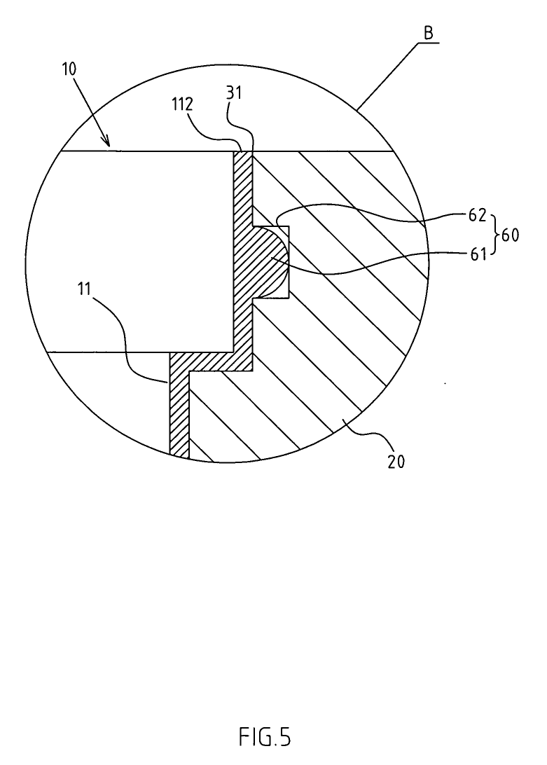

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

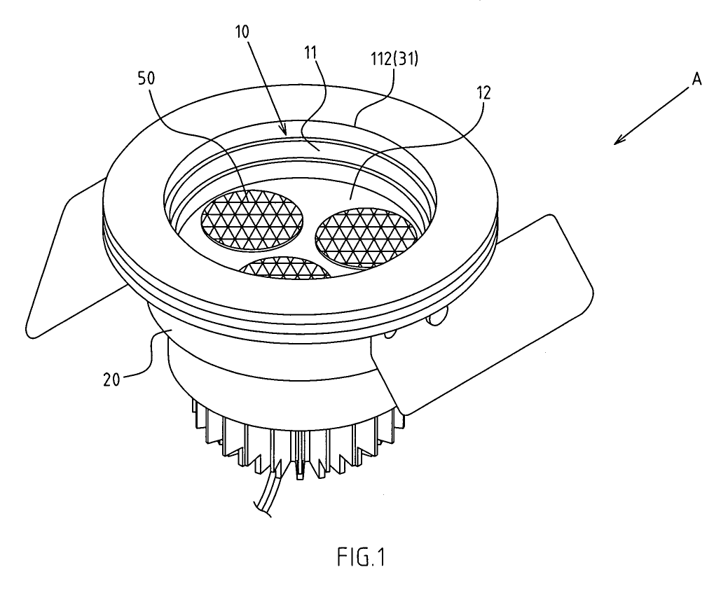

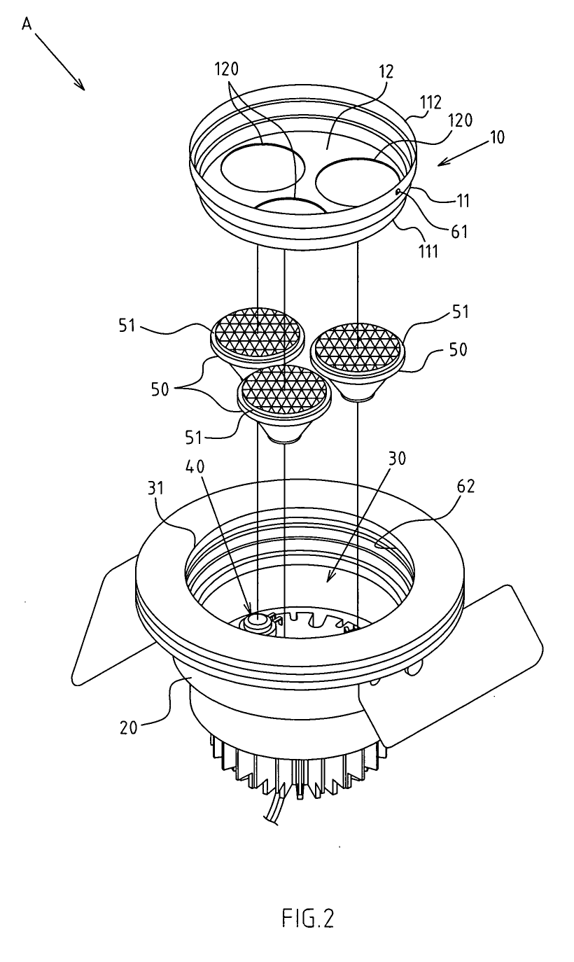

FIGS. 1-4 depict preferred embodiments of improved lampshade for an LED lamp of the present invention. The embodiments are only provided for explanatory purposes with respect to the patent claims.

The lampshade 10 is assembled onto the port 31 of hold tank 30 on the main body 20 of LED lamp A (an embedded light structure), so that light-reflection modules 50 located between port 31 of hold tank 30 and LED modules 40 in the hold tank 30 are positioned securely.

The lampshade 10 comprises a circumferential locating edge 11 and a limitation surface 12. The circumferential locating edge 11 is adapted with the wall edge of hold tank 30 to define an inner edge 111 and an external edge 112. The limitation surface 12 is recessed into inner edge 111 of the circumferential locating edge 11 and is provided with several through-holes 120 for sleeving and limitation of the light-reflection modules 50. The circumferential locating edge 11 and the wall edge of hold tank 30 are coupled with snapping portion 60.

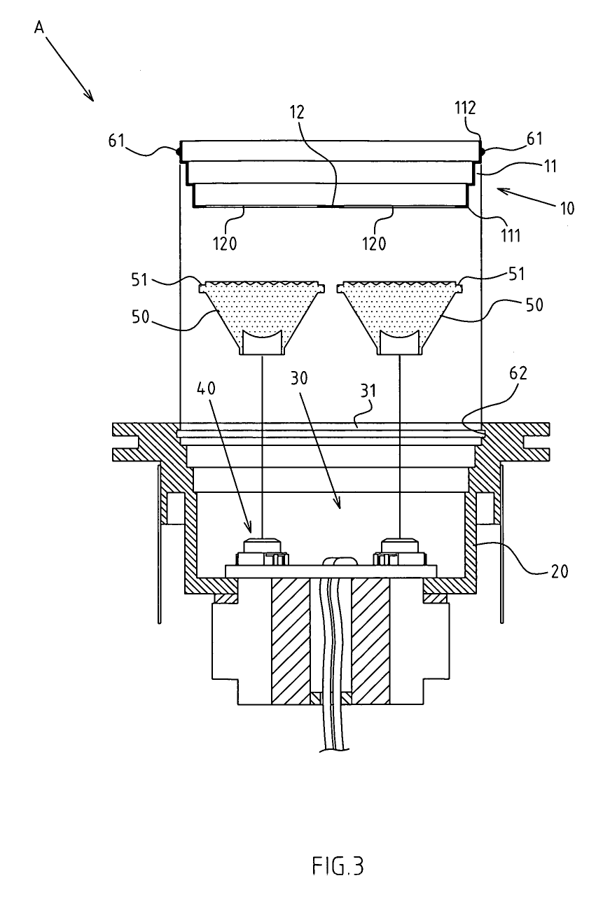

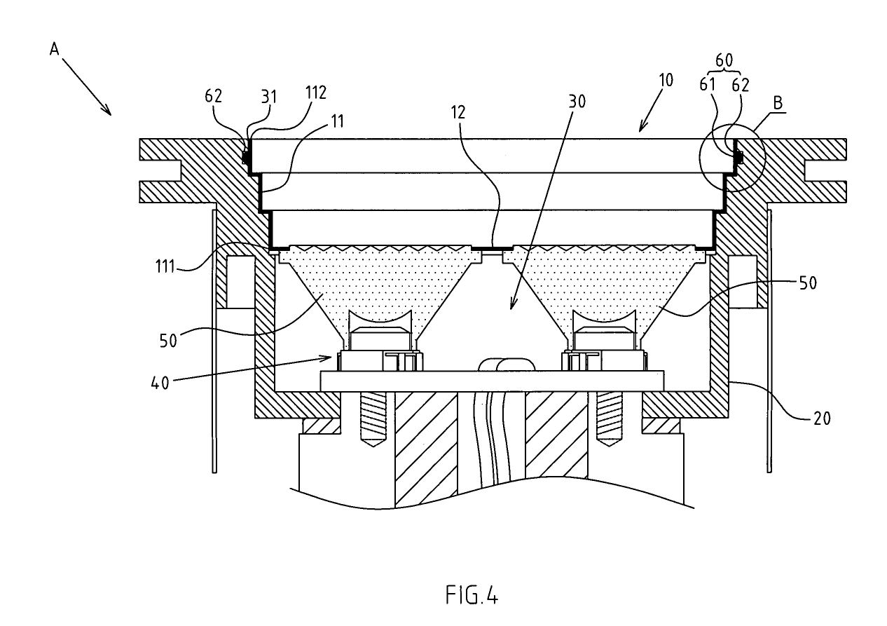

Referring to FIGS. 3 and 4, the snapping portion 60 comprises a few locating flanges 61, arranged at intervals on the circumferential locating edge 11 of the lampshade 10, and a circular snapping groove 62 on the wall edge of hold tank 30 of the main body 20. When the lampshade 10 is mounted into the hold tank 30 of main body 20, it could be snapped rapidly into the circular snapping groove 62 via the locating flange 61 for positioning purpose.

The circumferential locating edge 11 of the lampshade 10 has a stepped external wall with big and small necks, and the wall edge of the hold tank 30 has a stepped inner wall with big and small treads.

A shoulder 51 is formed at one end of the light-reflection module 50, so that it could be located in the through-hole 120 of the limitation surface 12 of the lampshade 10 to securely fix the light-reflection modules 50.

Based upon above-specified structures, the present invention is operated as follows:

Referring to FIGS. 3 and 4, when the port 31 of the hold tank 30 of the main body 20 faces upwards, the light-reflection modules 50 are first placed into hold tank 30 of the main body 20 opposite to the LEDs on LED module 40. Then, the lampshade 10 is assembled into the port 31 of the hold tank 30 of the main body 20. In such a case, the light-reflection modules 50 are fastened into the through-hole 120 on the limitation surface 12 of the lampshade 10 and are positioned through the circumferential locating edge 11 of the lampshade 10 and snapping portion 60 on the wall edge of the hold tank 30. Thus, both lampshade 10 and light-reflection module 50 are fixedly assembled and positioned with the main body 20.

1. A lampshade of an LED lamp, said LED lamp being assembled onto a port of a hold tank on a main body thereof, said LED lamp having light-reflection modules located between said port of said hold tank, said light-reflection modules and LED modules in said hold tank being positioned securely, said lampshade comprising:
a circumferential locating edge, adapted to a wall edge of said hold tank, defining an inner edge and an external edge;
a limitation surface, recessed into said inner edge of said circumferential locating edge, and provided with several through-holes, said several through-holes sleeving and limiting said light-reflection modules; and
a snapping portion, placed at a coupling portion of said circumferential locating edge and said wall edge of said hold tank.

2. The lampshade defined in claim 1, wherein said circumferential locating edge is comprised of a stepped external wall with a plurality of necks of different sizes, said wall edge having a stepped inner wall with a plurality of treads of different sizes.

3. The lampshade defined in claim 1, further comprising:
a shoulder formed at one end of one of the light-reflection module, said shoulder being located in a through-hole of a limitation surface.

4. The lampshade defined in claim 1, wherein said snapping portion comprises locating flanges, arranged on said circumferential locating edge, and a circular snapping groove, placed on said wall edge of said hold tank.
